(19) United States
(12) Patent Application Publication
(10) Pub. No.: US 2017/0351030 A1
(43) Pub. Date: Dec. 7, 2017

(54) FILTER ASSEMBLIES

(71) Applicant: Hewlett Packard Enterprise Development LP, Houston, TX (US)

(72) Inventors: Sagi Mathai, Sunnyvale, CA (US); Paul Kessler Rosenberg, Sunnyvale, CA (US); Michael Renne Ty Tan, Menlo Park, CA (US)

(21) Appl. No.: 15/172,176

(22) Filed: Jun. 3, 2016

(51) Int. Cl. G02B 6/293; G02B 6/38; G02B 6/42

(52) U.S. Cl. CPC G02B 6/29365; G02B 6/4244; G02B 6/2938; G02B 6/3845; G02B 6/4239

(57) ABSTRACT

In the examples provided herein, a mounting substrate includes a plurality of filter chips, where each filter chip includes a thin film filter coating on a surface of a different substrate, and the plurality of filter chips are positioned adjacent to each other in a row. A first edge of a first filter chip is flush with a first edge of the mounting substrate, a second edge of the first filter chip is flush with a second edge of the mounting substrate, and the first edge and second edge share a common corner. The flush edges of the first filter chip and the mounting substrate are reference surfaces, the plurality of filter chips are coupled to the mounting substrate via an epoxy, and the reference surfaces are to mate to connector reference surfaces on a connector.

### BACKGROUND

Wavelength division multiplexing (WDM) is useful for increasing communication bandwidth by sending multiple data channels down a single fiber. For example, a 100 gigabit per second (Gbps) link can be constructed by using four channels operating at 25 Gbps per channel, with each channel operating at a different wavelength. A multiplexer is used to join the signals together before transmitting them down the waveguide, and a demultiplexer is subsequently used to separate the signals.

### BRIEF DESCRIPTION OF THE DRAWINGS

The accompanying drawings illustrate various examples of the principles described below. The examples and drawings are illustrative rather than limiting.

FIG. 1A depicts an example multiplexer system that may use a filter assembly as described herein.

FIG. 1B depicts a side view of an example filter assembly and example optical connector with reference surfaces for passive alignment.

FIG. 1C depicts a bottom view of an example filter assembly and example optical connector with reference surfaces for passive alignment.

FIG. 2 depicts an example filter assembly having a mounting substrate and attached filter chips.

FIG. 3 depicts an example filter assembly having laterally stacked filter chips.

FIG. 4 depicts an example monolithic filter assembly.

FIG. 5A depicts another example monolithic filter assembly.

FIGS. 5B-5D depict example layouts including two monolithic filter assemblies.

### DETAILED DESCRIPTION

Described below are WDM filter assemblies that may be used in a multiplexer/demultiplexer system, where the filter assemblies and an optical connector have complementary references surfaces or features to enable passive alignment of a filter assembly in the optical connector during assembly.

In some implementations, the filter assembly may include a mounting substrate and a plurality of filters chips, where each filter chip includes a thin film filter coating on a surface of a different substrate. The filter chips are positioned adjacent to each other in a row. A first edge of a first filter chip is flush with a first edge of the mounting substrate, a second edge of the first filter chip is flush with a second edge of the mounting substrate, and the first edge and second edge share a common corner. The flush edges of the first filter chip and the mounting substrate are reference surfaces, the plurality of filter chips are coupled to the mounting substrate via an epoxy, and the reference surfaces are to mate to connector reference surfaces on a connector.

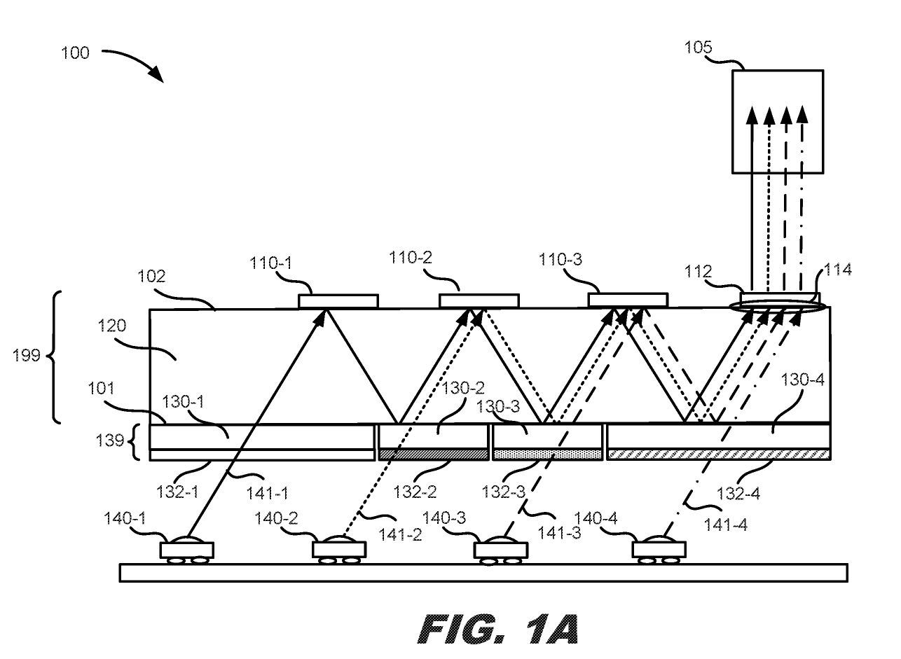

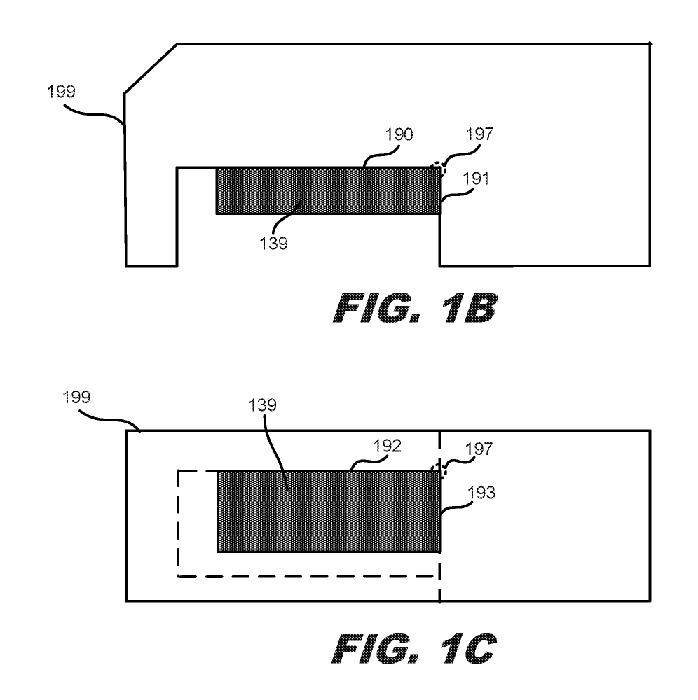

FIG. 1A depicts an example multiplexer system 100. In the example of FIG. 1A, four optical sources with integrated lenses 140 are shown, but any number of optical sources, greater than one, can be used. The optical sources 140 can be any type of light source that emits a light beam 141 in a band of wavelengths, such as a vertical-cavity surface-emitting laser (VCSEL), a distributed feedback laser, and a fiber laser. Light beams 141 are emitted by the optical sources 140 at different wavelengths and impinge on the optical body 120 at different input regions.

At each of the input regions of the optical body 120 where a light beam 141 impinges, there is a filter chip that may include a substrate 130 and a wavelength-selective filter 132. Each wavelength-selective filter 132 reflects light, e.g., at greater than 50% reflectivity, at a first set or group of wavelengths and transmits light, e.g., at greater than 50% transmissivity, at a second set or group of wavelengths. The first set of wavelengths is different from the second set of wavelengths, and each wavelength-selective filter 132 transmits a different second set of wavelengths. For example, the set of wavelengths emitted by optical source 140-1 that is transmitted by wavelength-selective filter 132-1 is different from the set of wavelengths emitted by optical source 140-2 that is transmitted by wavelength-selective filter 132-2, which is different from the set of wavelengths emitted by optical source 140-3 that is transmitted by wavelength-selective filter 132-3, and is also different from the set of wavelengths emitted by optical source 140-4 that is transmitted by wavelength-selective filter 132-4. In general, the peak wavelength of the optical source 140 is matched to the peak transmission wavelength of the wavelength-selective filter 132 to minimize optical power loss in the system 100. Wavelength-selective filters 132 can be made of multiple layers of dielectric material having different refractive indices.

Light beams transmitted by wavelength-selective filters 132-1, 132-2, 132-3 each travel from surface 101 of the optical body 120, through the optical body 120, to impinge upon a reflective focuser 110 coupled to the second surface 102 of the optical body 120. Each reflective focuser 110 reflects and focuses an incoming light beam back to a different one of the wavelength-selective filters 132 at the input regions of the optical body 120. Examples of a reflective focuser can include a multi-layer stack of dielectric thin films; a Fresnel lens; a curved mirror lens, such as made with a metallic surface, e.g., gold; and a high-contrast grating reflector.

Upon hitting a wavelength-selective filter 132, at least some portion of the light beam is reflected back toward the second surface 102 of the optical body 120. Each wavelength-selective filter 132, except for wavelength-selective filter 132-4 closest to the exit region 114, reflects light to one of the reflective focusers 110, as discussed above. Each wavelength-selective filter 132 also transmits a light beam from an optical source 140. Light within the optical body 120 is redirected alternately between the wavelength-selective filters 132 and the reflective focusers 110 until the light hits the wavelength-selective filter 132-4 closest to the exit region 114.

Wavelength-selective filter 132-4 reflects the light beam from within the optical body 120 to the exit region 114 on the second surface 102 of the optical body 120. Wavelength-selective filter 132-4 also transmits a light beam from the optical source 140-4. The reflected and transmitted light beams together make up the exit light beam that is directed toward the exit region 114. The exit beam light beam includes at least some light from each of the optical sources 140, thus, multiplexing the light beams from the optical sources 140.

Coupled to the exit region 114 is an output lens 112 configured to image the light beam to another location, such as the input to a transmission medium 105. The transmission medium 105 can be, for example, a multimode or single mode optical fiber or planar waveguide. The output lens 112 can also image the beam to an intermediate location. In some implementations, the output lens 112 is not present.

The optical body 120 can also operate as a demultiplexer (not shown), where a multi-wavelength light beam enters the optical body 120 at region 114 on the second surface 102 of the optical body 120. A portion of the multi-wavelength beam is transmitted by the wavelength-selective filter 132-4 to a detector.

Detectors can be any type of sensor capable of sensing the system operating wavelengths, such as a photodiode. Each detector is positioned to receive a light beam transmitted from a corresponding wavelength-selective filter 132. The wavelengths reflected by wavelength-selective filter 132-4 travel through the optical body 120 until a reflective focuser 110-3 coupled to the second surface 102 is reached. Similar to the multiplexer, light is re-directed within the optical body 120 alternately between the wavelength-selective filters 132 and the reflective focusers 110 until the light beam hits a wavelength-selective filter 132 that allows the light to exit the optical body 120. The light that exits the optical body is then focused by a detector lens onto the active area of a corresponding detector.

In some cases, the same optical body 120 can be used for both multiplexing and de-multiplexing signals. For example, the multiplexing portion can be adjacent to the demultiplexing portion, or the multiplexing portion can be interleaved with the demultiplexing region.

The filter chips 130-1, 132-1; 130-2, 132-2; 130-3, 132-3; 130-4, 132-4 may be replaced by a filter assembly 139, as described below. Filter assemblies may be fabricated monolithically or assembled from discrete filter chips. Filters may be manufactured on glass substrates as alternating layers of transparent dielectric materials, such as TiO₂ and SiO₂. Flatness of the filter chips may be maintained by using stress compensating anti-reflection coatings on the substrate surface opposite the filter coatings and/or by using thicker substrates. Final dimensions and sidewall geometry may be precisely controlled using modern dicing saws or laser dicing techniques.

An optical connector 199 that includes the optical block 120, reflective focusers 110, and output lens 112 may be manufactured using injection molding. Injection molding may be used to achieve very precise geometric and dimensional control while producing a high volume of parts. The optical connector 199 may be designed with multiple reference surfaces or reference features to mate with external parts, such as a filter assembly 139.

FIG. 1B depicts a side view of an example filter assembly 139 and example optical connector 199 with reference surfaces 190, 191 for passive alignment. In some implementations, the corner between reference surfaces 190, 191 may be an rounded corner 197, such as may be obtained by removing a portion of a spherical volume from the corner. An adhesive may be used between the filter assembly 139 and optical connector 199 at reference surface 190 after passive alignment has been attained.

FIG. 1C depicts a bottom view of an example filter assembly 139 and example optical connector 199 with reference surfaces 192, 193 for passive alignment.

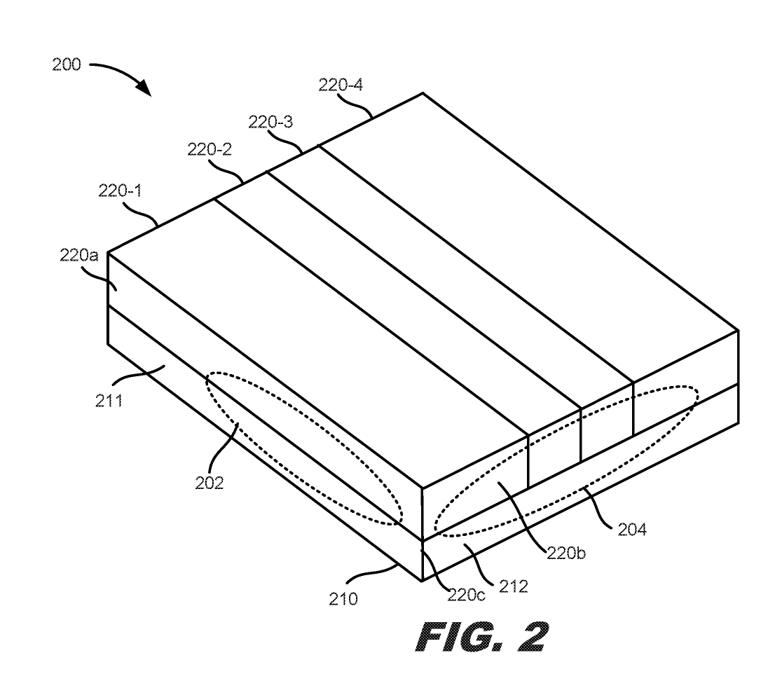

FIG. 2 depicts an example filter assembly 200 having a mounting substrate 210 and attached filter chips 220 positioned adjacent to each other in a row. Four filter chips 220 are shown, but any number of filter chips 220 can be used. As shown in the example of FIG. 2, the outer two filter chips in the row, 220-1, 220-4, are wider than the inner two filter chips, 220-2, 220-3 in the row. If there are more or fewer than four filter chips, the two filter chips at the ends of the row may be wider than the other filter chips in the row. By widening the end filter chips, 220-1, 220-4, a little more mechanical tolerance may be achieved because more chipping damage is permitted along the edges and more misalignment is allowed with respect to the optical connector. In some implementations, each filter chip 220-1, 220-2, 220-3, 220-4 in the row may have the same width.

A first edge 220a of a first filter chip 220-1 is flush with a first edge 211 of the mounting substrate 210 to create a first precision edge 202. The rest of the filter chips 220-2, 220-3, 220-4 are pushed against the first filter chip 220-1. A second edge 220b of the first filter chip 220-1 is flush with a second edge 212 of the mounting substrate, where the first edge 220a and second edge 220b share a common corner 220c. An edge of each of the other filter chips 220-2, 220-3, 220-4 are also pushed flush with the second edge 212 of the mounting substrate 210 to create a second precision edge 204. The filter chips 220 are coupled to the mounting substrate 210 via an epoxy. In some implementations, the epoxy is transparent at wavelengths reflected by the thin film filters of the filter chips 220.

The first precision edge 202 and the second precision edge 204, which include the flush edges of the first filter chip 220-1 and the mounting substrate 210, are reference surfaces, and the reference surfaces are to mate to connector reference surfaces on an optical connector, such as connector reference surfaces 192, 193 shown in the examples of FIGS. 1B and 1C.

In some implementations, the reference surfaces 202, 204 may be flat across the entire surface. In some implementations, the reference surfaces may have any shape and include, for example, serrated teeth. Contact at a single point between each of the references surfaces 202, 204 and the corresponding connector reference surfaces is sufficient. For example, the reference surfaces 202, 204 or the connector reference surfaces may have a bump that contacts the corresponding surface. Thus, in some implementations, at a minimum, the first edge 220a of the first filter chip 220-1 and the mounting substrate 210 contact a first connector surface at at least one point (a first point), and the second edge 220b of the first filter chip and the mounting substrate 210 contact a second connector surface at at least one point (a second point). However, contact is not limited to one point between corresponding surfaces; contact may occur at two or more points between surfaces.

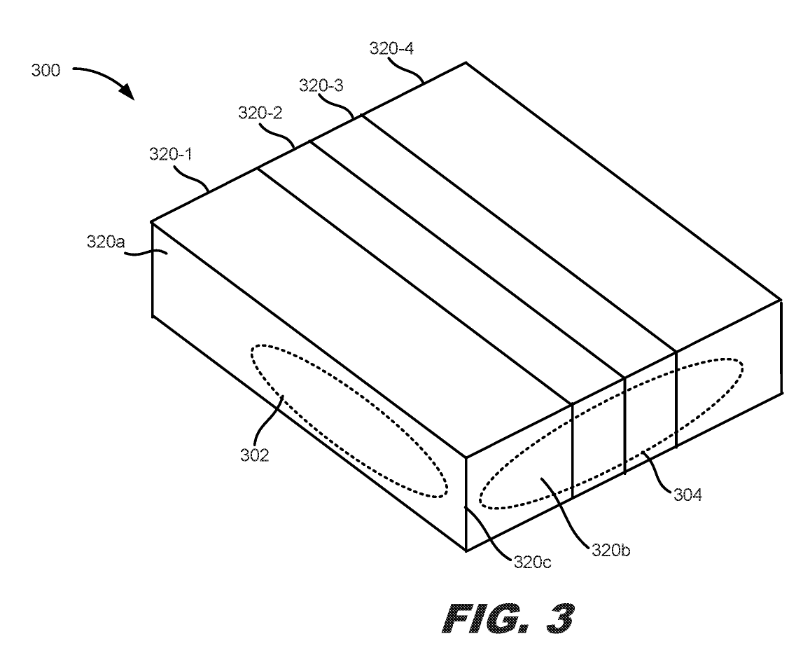

FIG. 3 depicts an example filter assembly 300 having a plurality of filter chips 320 positioned adjacent to each other in a row, such that the filter chips are laterally stacked. Each filter chip 320 includes a thin film filter coating on a surface of a different filter substrate. In contrast to the example of FIG. 2, there is no mounting substrate 210. Thus, in this implementation, the filter substrates are thicker than in the example of FIG. 2. The filter chips may have, but are not limited to, the same thickness. Four filter chips 320 are shown, but any number of filter chips 320 can be used. As shown in the example of FIG. 3, the outer two filter chips in the row, 320-1, 320-4, are wider than the inner two filter chips, 320-2, 320-3. If there are more or fewer than four filter chips, the two filter chips at the ends of the row may be wider than the other filter chips in the row, such that a width of the filter chips 320 is not uniform in the filter assembly. In some implementations, each filter chip 320-1, 320-2, 320-3, 320-4 in the row may have the same width.

A first edge 320a from a corner 320c of a first filter chip 320-1 serves as a first reference surface 302. The rest of the filter chips 320-2, 320-3, 320-4 are pushed against the first filter chip 320-1. A second edge 320b from the corner 320c of the first filter chip 320-1 serves a second reference surface 304. An edge of each of the other filter chips 320-2, 320-3, 320-4 is also flush with the second edge 320b of the first filter chip 320-1 and form part of the second reference surface 304. The filter chips 320 are coupled to each other via an epoxy on adjacent surfaces. In some implementations, the epoxy is transparent at wavelengths transmitted and reflected by the thin film filters of the filter chips 320.

The reference surfaces 302, 304 are to mate to connector reference surfaces on an optical connector, such as connector reference surfaces 192, 193 shown in the examples of FIGS. 1B and 1C. As discussed above with respect to reference surfaces 202, 204, reference surfaces 302, 304 may be flat across the entire reference surface, or the reference surfaces may be any shape and make contact at at least one point between each of the references surfaces 302, 304 and the corresponding connector reference surfaces is sufficient

In some implementations, the filter chips 320 may be positioned in a staggered manner relative to the second edge 320b of the first filter chip 320-1, such that each of the filter chips 320-2, 320-3, 320-4 are not necessarily flush with the second edge 320b.

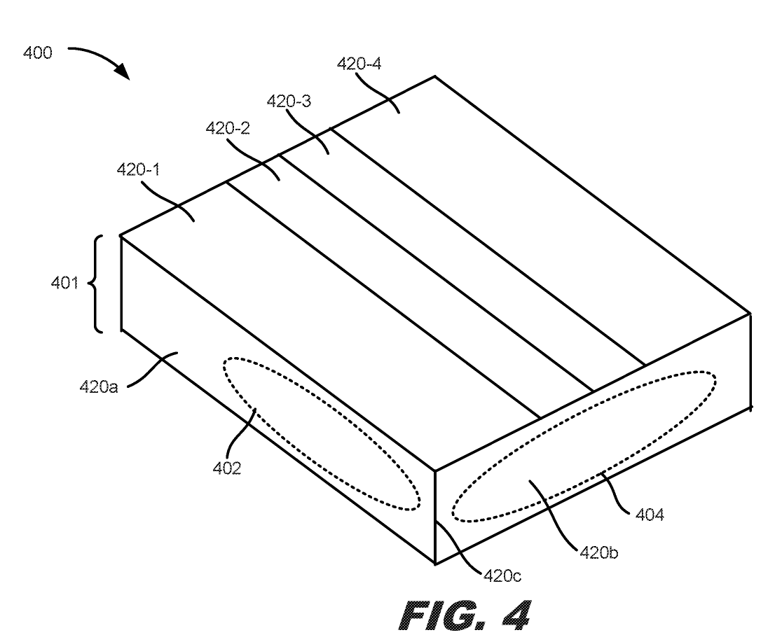

FIG. 4 depicts an example monolithic filter assembly 400. With a monolithic filter assembly, there are no discrete filter chips to be assembled. Instead, each filter 420 of a first plurality of filters is patterned in a strip on a first substrate 401, and the strips are positioned parallel to each other in a row. Four strips of filters 420 are shown, but any number of filters 420 can be used. A first filter 420-1 of the first plurality of filters 420 is flush with a first edge 420a extending from a corner 420c of the first substrate 401, and each of the first plurality of filters 420 are flush with a second edge 420b extending from the corner 420c of the first substrate 401. As shown in the example of FIG. 4, the outer two filters in the row, 420-1, 420-4, are wider than the inner two filters, 420-2, 420-3. If there are more or fewer than four filter chips, the two filter chips at the ends of the row may be wider than the other filter chips in the row, such that a width of the filter chips 420 is not uniform in the filter assembly. In some implementations, each filter chip 420-1, 420-2, 420-3, 420-4 in the row may have the same width.

To form the filters 420 on the first substrate 401, a liftoff technique may be used that places a photoresist layer on the substrate prior to depositing the thin film filter layers. Then the photoresist layer is removed. In the regions where the photoresist layer was not applied, the filter layers in those regions will remain. In the regions where the photoresist layer was present, the deposited thin film filter layers are removed. The process can be repeated to create multiple filters on the single substrate. In some implementations, the filters 420 may be immediately adjacent, while in other implementations, there may be a gap between two neighboring filters.

The first edge 420a and the second edge 420b of the first substrate 401 are a first reference surface 402 and a second reference surface 404, respectively. The first and second reference surfaces 402, 404 are to mate to a first and second connector reference surface, respectively, on a connector, such as connector reference surfaces 192, 193 shown in the examples of FIGS. 1B and 1C. As discussed above with respect to reference surfaces 202, 204, reference surfaces 402, 404 may be flat across the entire reference surface, or the reference surfaces may be any shape and make contact at at least one point between each of the references surfaces 402, 404 and the corresponding connector reference surfaces is sufficient.

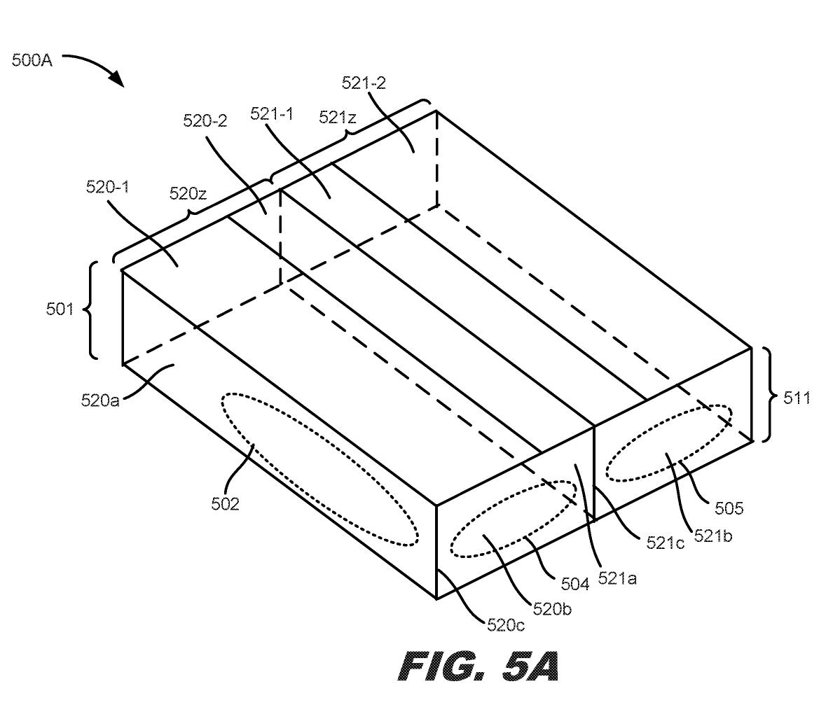

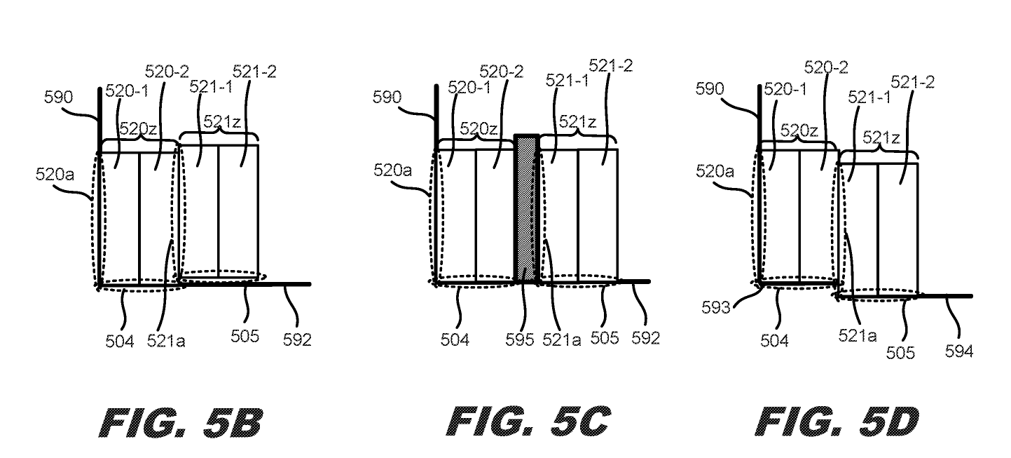

FIG. 5A depicts another example monolithic filter assembly 500. Again, in this implementation, there are no discrete filter chips to be assembled. Rather, two monolithic filter assemblies 520z, 521z, such as described in the example of FIG. 4 above, may be used together.

In the example of FIG. 5A, for a first monolithic filter assembly 520z, each filter of a first plurality of filters 520 is patterned in a strip on a first substrate 501, and the strips are positioned parallel to each other in a row. Two strips of filters 520 are shown in the example of FIG. 5A, but any number of filters 520 can be used. A first filter 520-1 of the first plurality of filters 520 is flush with a first edge 520a extending from a corner 520c of the first substrate 501, and each of the first plurality of filters 520 are flush with a second edge 520b extending from the corner 520c of the first substrate 501. The second edge 520b serves as a reference surface 504.

For a second monolithic filter assembly 521z, each filter of a second plurality of filters 521 is patterned in a strip on a second substrate 511, and the strips are positioned parallel to each other in a row. Two strips of filters 521 are shown in the example of FIG. 5A, but any number of filters 521 can be used. A first filter 521-1 of the second plurality of filters 521 is flush with a third edge 521a extending from a corner 521c of the second substrate 511, and each of the second plurality of filters 521 are flush with a fourth edge 521b extending from the corner 521c of the second substrate 511. The fourth edge 521b may serve as a reference surface 505. Additionally, at least one of the third edge 512a and the fourth edge 521b of the second substrate 511 is used as a reference surface.

In the example implementation of FIG. 5A, the first edge 520a of the first monolithic filter assembly 520z serves as a first reference surface 502. The third edge 521a of the second monolithic filter assembly 521z is pushed against the surface opposite the first edge 520a of the first monolithic filter assembly 520z. The second edge 520b of the first monolithic filter assembly 520z and the fourth edge 521b of the second monolithic filter assembly 521z are flush, creating a second reference surface 504-505. The first and second reference surfaces 502, 504-505 are to mate to a first and second connector reference surface, respectively, on a connector, such as connector reference surfaces 192, 193 shown in the examples of FIGS. 1B and 1C. In this implementation, the use of adhesive between the first and second monolithic filter assemblies 520z, 521z, may be foregone, to eliminate a potential point of failure.

In some implementations, the third edge 521a of the second substrate 511 is coupled via epoxy or other adhesive to an edge of the first substrate 501 that is opposite the first edge 520a, as shown in the example of FIG. 5B. In this case, the first edge 520a of filter 520-1 mates to a first connector reference surface 590, and reference surface 504 of the first monolithic filter assembly 520z mates with a second connector reference surface 592, while reference surface 505 of the second monolithic filter assembly 521z does not make contact with the second connector reference surface 592.

Alternatively, in some implementations, the third edge 521a of the second substrate 511 is to be coupled via epoxy or other adhesive to a mechanical feature 595 on the connector, as shown in the example of FIG. 5C. In this case, the first edge 520a of filter 520-1 mates to the first connector reference surface 590, and reference surface 504 of the first monolithic filter assembly 520z mates with the second connector reference surface 592. The reference surface 505 of the second monolithic filter assembly 521z also mates with the second connector reference surface 592.

In some implementations, the fourth edge 521b of the second substrate 511 is an additional reference surface 505, and the additional reference surface 505 is to mate to a third connector reference surface 594 on the connector, as shown in the example of FIG. 5D. In this case, the first edge 520a of filter 520-1 mates to the first connector reference surface 590, and reference surface 504 of the first monolithic filter assembly 520z mates with a second connector reference surface 593. The reference surface 505 of the second monolithic filter assembly 521z also mates with a third connector reference surface 594, where the second connector reference surface 593 and the third connector reference surface 594 are distinct.

In some implementations, the third connector reference surface 594 may be the same as the second connector reference surface 593.

As used in the specification and claims herein, the singular forms “a,” “an,” and “the” include plural referents unless the context clearly dictates otherwise.

1. A filter assembly comprising:
a mounting substrate;
a plurality of filter chips, wherein each filter chip includes a thin film filter coating on a surface of a different substrate,
wherein the plurality of filter chips are positioned adjacent to each other in a row,
wherein a first edge of a first filter chip is flush with a first edge of the mounting substrate, and a second edge of the first filter chip is flush with a second edge of the mounting substrate, and the first edge and second edge share a common corner,
wherein the flush edges of the first filter chip and the mounting substrate are reference surfaces,
wherein the plurality of filter chips are coupled to the mounting substrate via an epoxy, and
wherein the reference surfaces are to mate to connector reference surfaces on a connector.

2. The filter assembly of claim 1, wherein the epoxy is transparent at wavelengths reflected and transmitted by the thin film filters of the plurality of filter chips.

3. The filter assembly of claim 1, wherein the plurality of filter chips includes four filter chips, and wherein the outer two filter chips in the row are wider than the inner two filter chips.

4. The filter assembly of claim 1, wherein the first edge of the first filter chip and the mounting substrate contact a first connector surface at at least one point, and the second edge of the first filter chip and the mounting substrate contact a second connector surface at least one point.

5. A filter assembly comprising:
a plurality of filter chips, wherein each filter chip includes a thin film filter coating on a surface of a different filter substrate,
wherein the plurality of filter chips are positioned adjacent to each other parallel in a row,
wherein a first edge from a corner of a first filter chip and a second edge from the corner of the first filter chip are reference surfaces,
wherein a width of the plurality of filter chips is not uniform;
wherein the plurality of filter chips are coupled to each other via an epoxy on adjacent surfaces,
wherein the reference surfaces are to mate to connector reference surfaces on a connector.

6. The filter assembly of claim 5, wherein the epoxy is transparent at wavelengths reflected and transmitted by the thin film filters of the plurality of filter chips.

7. The filter assembly of claim 5, wherein the plurality of filter chips includes four filter chips, wherein the outer two filter chips in the row are wider than the inner two filter chips.

8. The filter assembly of claim 5, wherein the plurality of filter chips are positioned in a staggered manner relative to the second edge of the first filter chip.

9. A filter assembly comprising:
a first substrate;
a first plurality of filters, each filter patterned in a strip on the first substrate, and the strips of the first plurality of filters are positioned parallel to each other in a row,
wherein a first filter of the first plurality of filters is flush with a first edge extending from a corner of the first substrate, and each of the first plurality of filters are flush with a second edge extending from the corner of the first substrate,
wherein the first edge and the second edge of the first substrate are a first and second reference surface, respectively, and
wherein the first and second reference surfaces are to mate to a first and second connector reference surface, respectively, on a connector.

10. The filter assembly of claim 9, wherein there is a gap between two neighboring filters.

11. The filter assembly of claim 9, wherein the plurality of filters includes four filters, and wherein the outer two filters in the row are wider than the inner two filters.

12. The filter assembly of claim 9, further comprising:
a second substrate;
a second plurality of filters, each filter patterned in a strip on the second substrate, and the strips of the second plurality of filters are positioned parallel to each other in a row,
wherein a first filter of the second plurality of filters is flush with a third edge extending from a corner of the second substrate and each of the second plurality of filters are flush with a fourth edge extending from the corner of the second substrate,
wherein at least one of the third edge and the fourth edge is used as a reference surface.

13. The filter assembly of claim 12,
wherein the third edge of the second substrate is coupled via epoxy to an edge of the first substrate opposite the first edge or to be coupled via epoxy to a mechanical feature on the connector.

14. The filter assembly of claim 13,
wherein the fourth edge of the second substrate is an additional reference surface, and
wherein the additional reference surface is to mate to a third connector reference surface on the connector.

15. The filter assembly of claim 14,
wherein the third connector reference surface is the same as the second connector reference surface.
